(19) United States
(12) Patent Application Publication
(10) Pub. No.: US 2021/0015262 A1
(43) Pub. Date: Jan. 21, 2021

(54) MODULAR STANDING BOARD

(71) Applicant: Eddie L. Mitchell, III, Nipomo, CA (US)

(72) Inventor: Eddie L. Mitchell, III, Nipomo, CA (US)

(21) Appl. No.: 16/930,306

(22) Filed: Jul. 15, 2020

Related U.S. Application Data
(60) Provisional application No. 62/874,336, filed on Jul. 15, 2019.

(51) Int. Cl. A47B 97/00; A47G 27/02; F16B 1/00; A63B 22/18

(52) U.S. Cl. CPC A47B 97/00; A47G 27/0231; F16B 1/00; A63B 2208/0233; F16B 2001/0028; F16B 2001/0035; A47B 2200/0098; A63B 22/18

(57) ABSTRACT

A modular standing board for use with a standing desk or an adjustable height desk. The modular standing board includes a rigid base having an outer top perimeter which has a raised lip configured to securely contain a plurality of mat modules. The rigid base also has a bottom side having a recessed round area for receiving a balancing dome. The balancing dome has a flat top side and a curved bottom side. The flat top side of the balancing dome is magnetically attached to the recessed round area of the bottom of the rigid base. The plurality of mat modules provide a substantially continuous top surface when contained within the raised lip of the rigid base. The standing board alleviates problems that typically arise due to standing for a long time at a standing desk by providing a comfortable, balanced, and changeable standing board having swappable standing mat modules.

### CROSS-REFERENCE TO RELATED APPLICATION

The present application claims priority from Provisional Patent Application No. 62/874,336 filed Jul. 15, 2019, titled “Modular Standing Board”, which is hereby incorporated by reference in its entirety.

### FIELD OF THE INVENTION

The invention relates generally to devices to enhance prolonged standing, and particularly to standing boards.

### BACKGROUND OF THE INVENTION

Many people spend hours each day using a computer. Typically, people sit when using a computer. However, many people experience physical discomfort and/or physical problems due to too much time sitting. Consequently, some people have been using standing desks that support the computer at a height so they can use the computer while standing.

However, while using a computer supported by a standing desk, there comes a time for most people whereupon they become uncomfortable standing. Such people seek solutions to make prolonged standing more comfortable. One solution that is used is to employ a standing mat. However, known standing mats all share the same inherent problem: eventually the user adapts to it. After some time, such adaptation can cause boredom, distraction, discomfort, and possible injury.

### SUMMARY OF THE INVENTION

The invention is a modular standing board for use with a standing desk or an adjustable height desk. The invention is a solution to problems that arise due to standing for a long time at a standing desk. The invention solves these problems by providing a comfortable, balanced, and changeable standing board having swappable standing mat modules.

The modular standing board includes a rigid base which can be machined or molded from a variety of rigid materials, such as wood, plastic, or metal. Three to six contour-molded standing mat modules made from soft polyurethane or similar material provide a comfortable standing surface of the modular standing board. The standing mat modules are shaped so as to create what feels to a user's feet as a continuous surface. On the bottom of the standing board is a removable balancing dome made from hard polyurethane, soft foam, rubber, or plastic.

When the balancing dome is removed, the standing board can be used when set on the ground just resting on four rubber stoppers, thereby providing a fixed stable platform, rather than balancing on the balancing dome.

The rigid base is long and wide enough to comfortably support a large adult with enough room for lateral or longitudinal movement.

In addition, the bottom of the rigid base can be slightly tapered from the center to the outer edges so as to allow even more freedom of vertical movement than provided by use of the balancing dome.

The tapered bottom of the rigid base allows more movement while using a smaller (shorter) balancing dome, thereby making the rigid base a bit lower to the ground (and therefore safer, while also being easier to matchup the user's height with the desk). The tapered bottom of the rigid base also advantageously reduces the overall weight of the rigid base. With a thin balancing dome and a rubber stopper at each of the four corner regions of the rigid base, the standing board can provide a fixed position usage option. The tapered bottom of the rigid base also advantageously reduces the overall weight of the rigid base.

A general aspect of the invention is a modular standing board for use with a standing desk or an adjustable height desk. The modular standing board includes: a rigid base, the rigid base having an outer top perimeter, the outer top perimeter having a raised lip configured to house a plurality of mat modules, the rigid base also having a bottom side, the bottom side having a recessed round area for receiving a balancing dome, the recessed round area having a perimeter specifically matching the perimeter of a flat side of the balancing dome; a plurality of mat modules configured so as to provide a substantially continuous top surface when housed within the raised lip of the rigid base; and a balancing dome, the balancing dome having a flat top side and a curved bottom side, the flat top side of the balancing dome configured to be attached to the recessed round area of the bottom of the rigid base.

In some embodiments, the modular standing board further includes: a ferrous metal insert in the rigid base; and magnets on the flat top side of the balancing dome, the magnets configured to be cooperative with the ferrous metal insert such that the balancing dome can be securely yet removably attached to the underside of the rigid base.

In some embodiments, the balancing dome has hook or loop material on the flat side, and loop or hook material is attached inside a round recessed area on the underside of the rigid base for receiving the flat side of the balancing dome, so that the balancing dome can be removably attached to the underside of the rigid base by mating hook material with loop material.

In some embodiments, the modular standing board further includes: a stopper attached under each corner region of the rigid base, each stopper configured to limit rocking movement of the rigid base, prevent skidding of the rigid base across the floor, and prevent damage to the corners of the rigid base.

In some embodiments, the rigid base is made from one of: wood, plastic, or metal.

In some embodiments, the modular standing board further includes: a ferrous metal insert in the rigid base, the ferrous metal insert configured to provide a ferrous surface for magnetic attachment of mat modules; and at least one magnet in each mat module, the magnets configured to be cooperative with the ferrous metal insert such that the mat modules can be securely yet removably attached to the top of the rigid base.

In some embodiments, the bottom surface of the rigid base is tapered so as to be thickest in the center, and so as to become thinner as one moves outward from the center.

In some embodiments, the bottom surface of the rigid base is flat.

In some embodiments, the rigid base is configured to support a large adult.

In some embodiments, the rigid base has a perimeter, and the perimeter includes cutouts configured to facilitate handling of the rigid base, and configured to facilitate removal of each mat module placed on the top surface of the rigid base by applying upward pressure from below each mat module.

In some embodiments, the plurality of mat modules consists of three to six mat modules.

In some embodiments, each mat module has a bottom surface, each bottom surface has multiple small bored-out recesses, each bored-out recess houses a magnet, each magnet being configured to be removably attached to the top surface of the rigid base.

In some embodiments, each magnet is covered with a thin layer of fabric.

In some embodiments, each mat module has hook or loop material attached to the bottom surface thereof, and the rigid base has loop or hook material attached to the top surface thereof, the hook and loop material being configured to attach each mat module to the rigid base.

In some embodiments, the rigid base includes a grid of three to six sections, the grid being configured to separately receive and house each of the mat modules.

In some embodiments, each of the plurality of mat modules is made from soft polyurethane configured to provide a comfortable standing surface.

In some embodiments, the balancing dome is made from one of: hard polyurethane, rubber, soft foam, or plastic.

In some embodiments, the balancing dome is configured to be removable.

In some embodiments, the plurality of mat modules are each shaped differently from each other.

In some embodiments, a central mat module of the plurality of mat modules has a top surface, and the top surface includes a dome shape over a portion of the top surface.

### BRIEF DESCRIPTION OF THE DRAWINGS

Many additional features and advantages will become apparent to those skilled in the art upon reading the following description, when considered in conjunction with the accompanying drawings, wherein:

FIG. 1A is a top perspective view of an embodiment of the modular standing board, this embodiment including a standing mat module having a small convex upper dome, and three standing mat modules having surfaces with round bumps, all standing mat modules supported by a rigid base.

FIG. 1B is a top perspective view of another embodiment of the modular standing board, this embodiment including a standing mat module with a large convex upper dome, and three standing mat modules having surfaces without round bumps, all standing mat modules supported by a rigid base.

FIG. 1C is a cross-sectional view of the embodiment of FIG. 1B, also showing the magnets embedded within two of the standing mat modules without round bumps, and the magnet within a balancing dome supporting the rigid base.

FIG. 2A is a bottom perspective view of the embodiments of FIGS. 1A and 1B, showing the underside of the rigid base and the balancing dome, also showing a stopper under each corner region of the rigid base, and four handle slots in the rigid base.

FIG. 2B is a bottom perspective exploded view of the rigid base of FIG. 2A, showing the balancing dome and a round recessed area in the rigid base for receiving the balancing dome, also showing a stopper under each corner region, and the four handle slots.

FIG. 2C is a front view of the embodiment of FIG. 2A, showing the balancing dome, two of the stoppers, and a slightly tapered (convex) bottom surface of the rigid base.

FIG. 3 is a top perspective exploded view of the embodiment of FIG. 1B, showing four standing mat modules, and showing the rigid base having a raised lip around the top perimeter of the rigid base, the raised lip configured to house the standing mat modules in a joined manner.

FIG. 4 is a top perspective exploded view of the rigid base of the embodiments of FIGS. 1A and 1B, showing a thin metal insert for providing magnetic attachment of the standing mat modules, and how the thin metal insert fits into a shallow recessed area in the rigid base.

FIG. 5 is a perspective view of a person standing on the embodiment of the modular standing board of FIG. 1B, and in front of a standing desk setup.

### DETAILED DESCRIPTION

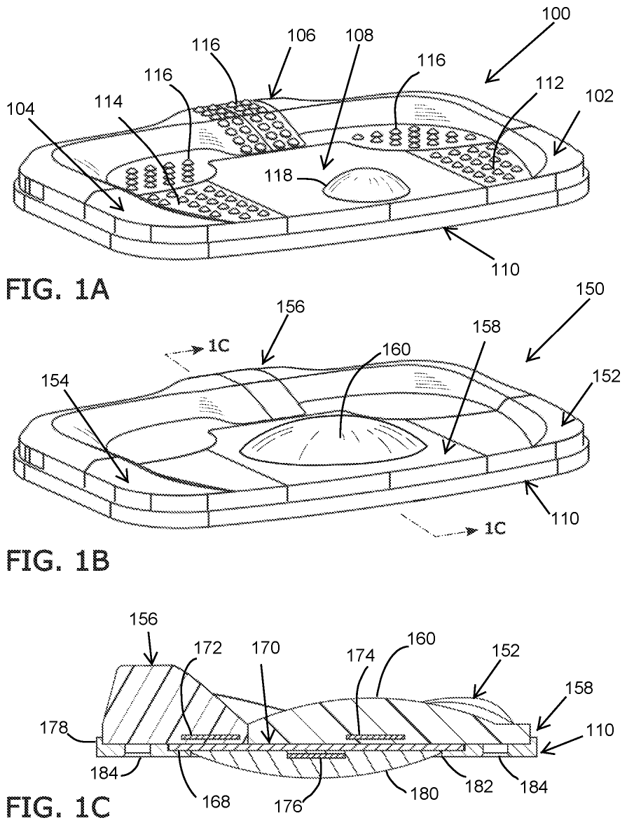

With reference to FIG. 1A, an embodiment 100 of a modular standing board for use with a standing desk or an adjustable height desk is shown. This embodiment of the modular standing board 100 includes four swappable standing mat modules 102, 104, 106, 108, supported on a rigid base 110. The rigid base 110 is long and wide enough to comfortably support a large adult with enough room for lateral or longitudinal movement.

In other exemplary embodiments, the number of mat modules can range from three to six. The rigid base 110 can be machined or molded from a variety of rigid materials, such as wood, plastic, or metal.

In this particular embodiment 100, mat modules 102 and 104 are mirror images of each other, and each include a surface having a distribution of a plurality of rounded bumps 112 and 114 respectively. The mat module 106 spans the rear of the modular standing board 100, and includes an arrangement of rounded bumps 116 disposed on a bilaterally symmetric contoured surface, as shown in FIG. 1A. The central mat module 108 includes a small convex upper dome 118. A version of these mat modules without rounded bumps is shown in FIG. 1B.

With reference to FIG. 1B, an embodiment 150 of a modular standing board for use with a standing desk or an adjustable height desk is shown. This embodiment 150 of the standing board includes four swappable standing mat modules 152, 154, 156, 158, each of which has a contoured surface, but without any rounded bumps. Note that mat module 158 has a large convex upper dome 160, whereas the mat module 108 of FIG. 1A has a small convex upper dome 118.

The standing mat modules 102, 104, 106, 108, 152, 154, 156, 158 are made from soft polyurethane or similar material so as to provide a comfortable standing surface of the modular standing board. The standing mat modules 102, 104, 106, 108, 152, 154, 156, 158 are shaped (contoured) so as to create what feels to a user's feet as a continuous surface.

With reference to FIG. 1C, the embodiment of FIG. 1B is presented in cross-section, showing mat modules 156, 158, and 152, as well as the rigid base 110. This cross-sectional view shows a shallow recessed area 168 on a top surface of the rigid base 110 that accommodates a thin metal insert 170 that provides extra support, and that also provides a ferrous surface for magnetic attachment of mat modules and a balancing dome. The thin metal insert 170 can be attached to the rigid base 110 using metal fasteners (e.g., screws) or using an adhesive.

The mat modules 156 and 158 are magnetically attached to the thin metal insert 170. For example, mat module 156 includes a magnet 172, and mat module 158 include a magnet 174. Similarly, each of the other mat modules incorporates a magnet too.

On the bottom of the standing board 100 is a removable balancing dome 180 made from hard polyurethane, soft foam rubber, solid rubber, or plastic. The removable balancing dome 180 includes a magnet 176 that serves to magnetically attach the balancing dome 180 to the bottom of the rigid base 110. The bottom of the rigid base 110 can include a recess 182 having substantially the same circumference as the balancing dome 180 to help maintain the dome 180 in place.

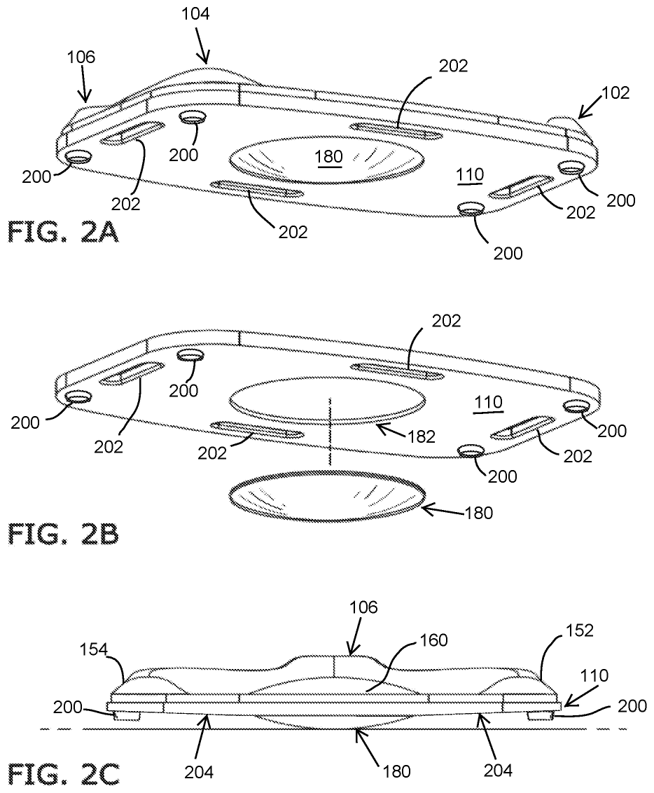

The recesses 184 receive optional stops 200 (see FIGS. 2A, 2B, 2C) that can be used to limit rocking motions when a user stands on the standing board 100 including the removable balancing dome 180.

Above the thin metal insert 170 can be an optional modular grid (not shown) of three to six sections (one section per mat module) which helps to firmly house each of the individual mat modules.

Also shown is a raised lip 178 around the outer top perimeter of the rigid base 110. The raised lip 178 serves to uniformly house the mat modules 152, 154, 156, 158 in a joined manner so as to provide a surface that feels substantially continuous to one standing on the modular standing board 100.

Referring to FIG. 2A, a bottom perspective view is provided of the embodiments 100 and 150, showing the underside of the rigid base 110 having a balancing dome 180, a stopper 200 under each corner region, and four handle slots 202. The mat modules 102, 104, and 106 are also shown resting on top of the rigid base 110.

With reference to FIG. 2B, a bottom perspective exploded view is provided of the rigid base 110 of embodiments 100 and 150, showing the balancing dome 180 that fits within the round recessed area 182 in the rigid base 110. Also shown are the fours stopper 200, one stopper 200 under each corner region, and the four handle slots 202, one handle slot 202 on each side.

Referring to FIG. 2C, a front view of the embodiment 150 is provided, showing the balancing dome180, two of the stoppers 200, and the tapered bottom surface 204 of the rigid base 110.

The tapered bottom surface 204 of the rigid base 110 is preferably slightly tapered from the center to the outer edges so as to allow even more freedom of vertical movement than provided by use of the balancing dome 180.

The tapered bottom surface 204 of the rigid base 110 allows more movement while using a smaller (shorter) balancing dome, thereby making the rigid base 110 a bit lower to the ground (and therefore safer, while also being easier to matchup the user's height with the desk). The tapered bottom surface 204 of the rigid base 110 also advantageously reduces the overall weight of the rigid base 110.

The outer edges of the rigid base 110 can also be rounded so as to provide a more finished appearance, and to remove possibly dangerous sharp edges.

As shown in FIGS. 2A and 2B, for example, on the perimeter of the rigid base 110 are cutout handles 202 along each side of the board which facilitate handling of the rigid base 110, and which also facilitate removal of any mat modules placed on its top surface by applying upward pressure through a cutout handle 202 from below a seated module to be removed and possibly swapped out to be replaced by a mat module of the same footprint on the rigid base 110, but with different surface features.

Each standing mat module can be removably attached to the top surface of the rigid base 110 with multiple magnets underneath each module, such as shown in FIG. 1C. The magnets are inserted into small bored-out recesses under each module. The magnets are covered with a thin protective layer fabric using an adhesive.

Alternatively, each standing mat module can be attached to the rigid base 110 using hook and loop material similar to Velcro®, for example. Hook material is attached to the bottom of each standing mat module, while loop material is attached to the rigid base 110, or vice versa. In this embodiment, hook and loop material replaces magnetic attachment, and so the rigid base 110 does not have a shallow recess on its top surface for receiving a thin metal insert 168, because no ferrous surface is needed for magnetic attachment of the standing mat modules to the rigid base 110.

The shape of these standing mat modules when inserted into the raised lip section 178 of the rigid base 110, and attached to the ferrous surface of the metal insert 168, creates a substantially continuous surface felt by the feet of the user. The overall shape of the board's top surface that these modules together create comfortably stimulates and supports use of as many groups of muscle, tendons, and bone as possible.

On the bottom side of the rigid base 110 is a slightly recessed round area 182, as shown in FIGS. 1C and 2B, for receiving a balancing dome 180, the recessed round area 182 having a perimeter specifically matching the perimeter of a flat side of the balancing dome 180. The recessed round area 182 helps to secure the balancing dome 180 in place, thereby enhancing safety. This balancing dome 180 is fitted with magnets 176 on the flat side of the dome 180, similar to or larger than the magnets 172 and 174 embedded in each of the individual mat modules 156 and 158. The balancing dome 180 can be between 0.25″ and 4.5″ in height, where 0.25″ provides the smallest range of motion, and 4.5″ provides the largest range of motion.

Because of the ferrous metal insert 168 and the magnets on the flat side of the balancing dome 180, the balancing dome 180 can be securely yet removably attached to the rigid base 110.

In an alternate embodiment, the balancing dome 180 is attached to the underside of the base using hook and loop material similar to Velcro®, for example. The hook material is attached to the flat side of the balancing dome 180, while loop material is attached inside the round recessed area 182 on the underside of the rigid base 110 for receiving the balancing dome 180, or vice versa.

Thus, since the balancing dome 180 can be removed, there is a stable mode of use without a balancing dome 180 for providing stable posture, as well as a balancing mode of use when the balancing dome 180 is included for providing dynamic posture. The balancing dome 180 can be made of polyurethane, or other similar material that can be of various densities so as to provide different balancing actions. If the balancing dome 180 is made of a soft material, the balancing motion will feel very stable and cushioned. If the balancing dome 180 is made of a hard material, the balancing motion will feel quite challenging.

As shown in FIGS. 2A, 2B, and 2C, the underside of the rigid base 110 can include rubber stoppers 200 located near the outer edges of the rigid base 110 to prevent damage to the rigid base 110 while balancing, and to also act as anti-skid surfaces when used without a balancing dome.

With a thin (0.25″) balancing dome 180 and a rubber stopper 200 at each of the four corner regions of the rigid base 110, the standing board 100 will still have a fixed position usage option.

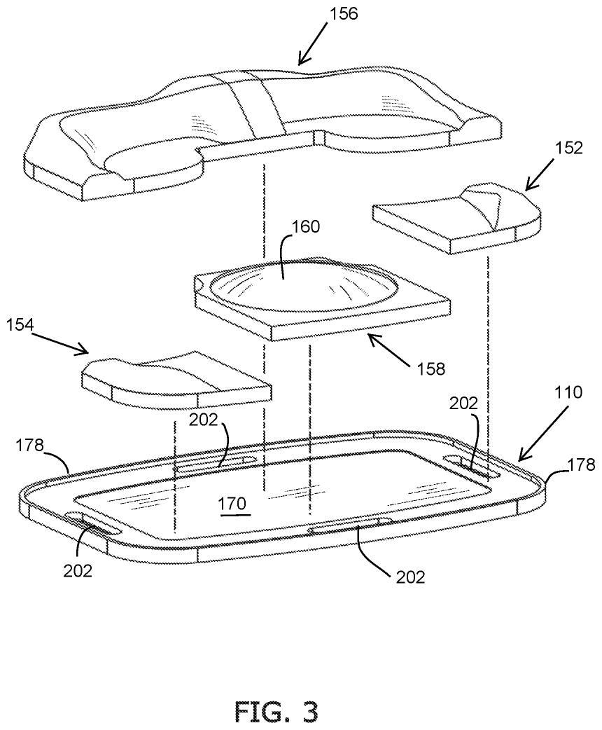

With reference to FIG. 3, a top perspective exploded view of the embodiment 150 of FIG. 1B is provided, showing four standing mat modules 152, 154, 156, and 158. Also shown is the rigid base 110 having a raised lip 178 around the top perimeter of the rigid base 110, the raised lip 178 shaped so as to house the standing mat modules 152, 154, 156, and 158 in a joined manner, thereby providing a substantially seamless surface. Note that the standing mat modules 152 and 154 are mirror images of each other, and that the standing mat module 156 exhibits bilateral symmetry. Also shown is the metal insert 170, and the four handles 202 in the rigid base 110.

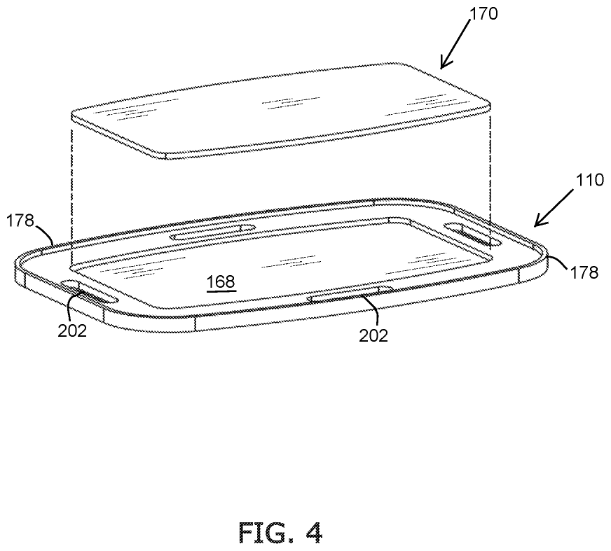

Referring to FIG. 4, a top perspective exploded view is shown of the rigid base of the embodiments of FIGS. 1A and 1B. A thin metal insert 170 fits into a shallow recessed area 168 in the rigid base 110. The magnets 172 and 174 in the standing mat modules 156 and 158 shown in FIG. 1C, for example, are attracted magnetically to the thin metal insert 170. The magnetic attraction helps to keep the standing mat modules within the raised lip 178 surrounding the outer top perimeter of the rigid base 110, thereby uniformly and securely housing the standing mat modules.

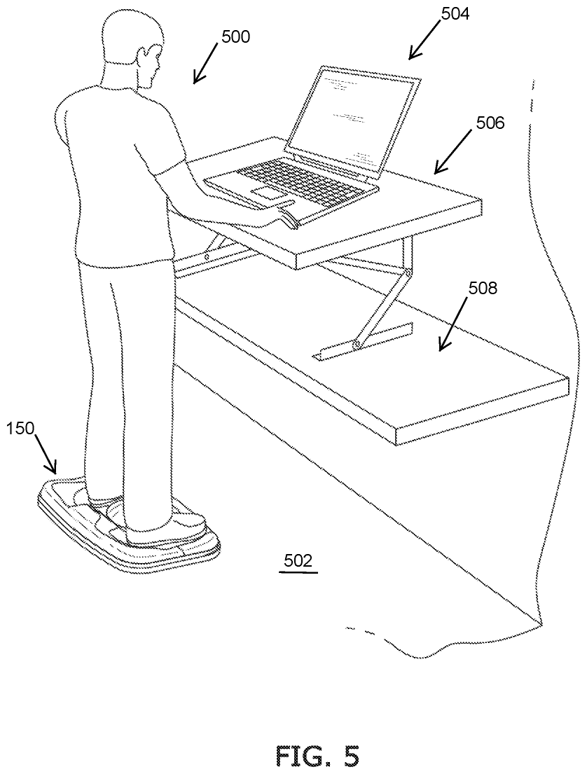

With reference to FIG. 5, a person 500 is shown standing on the embodiment 150 of the modular standing board of FIG. 1B. The standing board 150 is placed at a position on the floor 502 in front of a standing desk setup so as to provide comfortable access to the computer 504 placed on an adjustable height desk 506 supported by a standard height desk. Alternatively, the computer could be supported on an adjustable height desk (not shown) standing directly on the floor 502. Also note that the standing board 100 or 150 can also be used rotated 180 degrees, where the front becomes the rear, and vice versa, so as to provide yet another use variation.

Other modifications and implementations will occur to those skilled in the art without departing from the spirit and the scope of the invention as claimed.

Accordingly, the above description is not intended to limit the invention, except as indicated in the following claims.

What is claimed is:

1. A modular standing board for use with a standing desk or an adjustable height desk, the modular standing board comprising:
a rigid base, the rigid base having an outer top perimeter, the outer top perimeter having a raised lip configured to house a plurality of mat modules, the rigid base also having a bottom side, the bottom side having a recessed round area for receiving a balancing dome, the recessed round area having a perimeter specifically matching the perimeter of a flat side of the balancing dome;
a plurality of mat modules configured so as to provide a substantially continuous top surface when housed within the raised lip of the rigid base; and
a balancing dome, the balancing dome having a flat top side and a curved bottom side, the flat top side of the balancing dome configured to be attached to the recessed round area of the bottom of the rigid base.

2. The modular standing board of claim 1, further comprising:
a ferrous metal insert in the rigid base; and
magnets on the flat top side of the balancing dome, the magnets configured to be cooperative with the ferrous metal insert such that the balancing dome can be securely yet removably attached to the underside of the rigid base.

3. The modular standing board of claim 1, wherein the balancing dome has hook or loop material on the flat side, and loop or hook material is attached inside a round recessed area on the underside of the rigid base for receiving the flat side of the balancing dome, so that the balancing dome can be removably attached to the underside of the rigid base by mating hook material with loop material.

4. The modular standing board of claim 1, further comprising:
a stopper attached under each corner region of the rigid base, each stopper configured to limit rocking movement of the rigid base, prevent skidding of the rigid base across the floor, and prevent damage to the corners of the rigid base.

5. The modular standing board of claim 1, wherein the rigid base is made from one of: wood, plastic, or metal.

6. The modular standing board of claim 1, further comprising:
a ferrous metal insert in the rigid base, the ferrous metal insert configured to provide a ferrous surface for magnetic attachment of mat modules; and
at least one magnet in each mat module, the magnets configured to be cooperative with the ferrous metal insert such that the mat modules can be securely yet removably attached to the top of the rigid base.

7. The modular standing board of claim 1, wherein the bottom surface of the rigid base is tapered so as to be thickest in the center, and so as to become thinner as one moves outward from the center.

8. The modular standing board of claim 1, wherein the bottom surface of the rigid base is flat.

9. The modular standing board of claim 1, wherein the rigid base is configured to support a large adult.

10. The modular standing board of claim 1, wherein the rigid base has a perimeter, and the perimeter includes cutouts configured to facilitate handling of the rigid base, and configured to facilitate removal of each mat module placed on the top surface of the rigid base by applying upward pressure from below each mat module.

11. The modular standing board of claim 1, wherein the plurality of mat modules consists of three to six mat modules.

12. The modular standing board of claim 1, wherein each mat module has a bottom surface, each bottom surface has multiple small bored-out recesses, each bored-out recess houses a magnet, each magnet being configured to be removably attached to the top surface of the rigid base.

13. The modular standing board of claim 12, wherein each magnet is covered with a thin layer of fabric.

14. The modular standing board of claim 1, wherein each mat module has hook or loop material attached to the bottom surface thereof, and the rigid base has loop or hook material attached to the top surface thereof, the hook and loop material being configured to attach each mat module to the rigid base.

15. The modular standing board of claim 1, wherein the rigid base includes a grid of three to six sections, the grid being configured to separately receive and house each of the mat modules.

16. The modular standing board of claim 1, wherein each of the plurality of mat modules is made from soft polyurethane configured to provide a comfortable standing surface.

17. The modular standing board of claim 1, wherein the balancing dome is made from one of: hard polyurethane, rubber, soft foam, or plastic.

18. The modular standing board of claim 1, wherein the balancing dome is configured to be removable.

19. The modular standing board of claim 1, wherein the plurality of mat modules are each shaped differently from each other.

20. The modular standing board of claim 1, wherein a central mat module of the plurality of mat modules has a top surface, and the top surface includes a dome shape over a portion of the top surface.
